(19) United States
(12) Patent Application Publication
(10) Pub. No.: US 2008/0101725 A1
(43) Pub. Date: May 1, 2008

(54) Image display system configured to update correspondences using arbitrary features

(76) Inventors: I-Jong Lin, Palo Alto, CA (US); Niranjan Damera-Venkata, Palo Alto, CA (US); Nelson Chang, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/586,758

(22) Filed: Oct. 26, 2006

(51) Int. Cl. G06K 9/36

(52) U.S. Cl. 382/286

(57) ABSTRACT

A method performed by an image display system is provided. The method includes identifying a first arbitrary feature that is inherent in a first image frame and suitable for use as a first fiducial mark when the first image frame is displayed on a display surface by a display device and updating correspondence information between the display device and an image capture device using the first arbitrary feature in the first image frame and an image that is captured to include the first arbitrary feature on the display surface.

### CROSS-REFERENCE TO RELATED APPLICATIONS

This application is related to U.S. patent application Ser. No. 11/080,583, filed Mar. 15, 2005, and entitled PROJECTION OF OVERLAPPING SUB-FRAMES ONTO A SURFACE; and U.S. patent application Ser. No. 11/080,223, filed Mar. 15, 2005, and entitled PROJECTION OF OVERLAPPING SINGLE-COLOR SUB-FRAMES ONTO A SURFACE. These applications are incorporated by reference herein.

### BACKGROUND

In projection systems, such as digital light processor (DLP) systems and liquid crystal display (LCD) systems, it is often desirable to precisely calibrate the location of displayed images on a display surface. With many projection systems, however, the calibrated display location on the display surface may vary over time due to vibrations or environmental changes such as temperature variations. It would be desirable to be able to account for these variations without interrupting the display of images by the projection system.

### SUMMARY

According to one embodiment, a method performed by an image display system is provided. The method includes identifying a first arbitrary feature that is inherent in a first image frame and suitable for use as a first fiducial mark when the first image frame is displayed on a display surface by a display device and updating correspondence information between the display device and an image capture device using the first arbitrary feature in the first image frame and an image that is captured to include the first arbitrary feature on the display surface.

### BRIEF DESCRIPTION OF THE DRAWINGS

FIG. 1 is a block diagram illustrating one embodiment of an image display system.

FIG. 2 is a flow chart illustrating one embodiment of a method for adaptively generating camera-to-display device correspondence information.

FIG. 3 is a diagram illustrating one embodiment of generating updated camera-to-display device correspondence information.

FIG. 4 is a block diagram illustrating one embodiment of an image display system.

FIGS. 5A-5D are schematic diagrams illustrating one embodiment of the projection of four sub-frames.

FIG. 6 is a flow chart illustrating one embodiment of a method for adaptively generating camera-to-projector correspondence information.

FIGS. 7A-7B are diagrams illustrating one embodiment of generating camera-to-projector correspondence information.

FIG. 8 is a diagram illustrating one embodiment of a model of an image formation process.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

As described herein, a system and method for adaptively generating correspondence information in an image display system using arbitrary features is provided. The correspondence information may be periodically or continuously updated during normal operation of the image display system. To do so, the system and method identify inherent, arbitrary features of a still or video image. The system and method generates correspondences between the features in a space of a display device used to display the image on a display surface and a camera space of a camera used to capture an image of the display surface that includes the displayed image. The system and method updates correspondence information between the display device and the camera using correspondences currently found on the displayed image. Image display system uses the updated correspondence information to generate subsequent image frames for display on the display surface. Accordingly, the image display system may be updated during normal operation without interrupting the viewing of images from the system.

### I. Adaptive Generation of Camera-to-Display Device Correspondence Information in Non-Overlapping Images

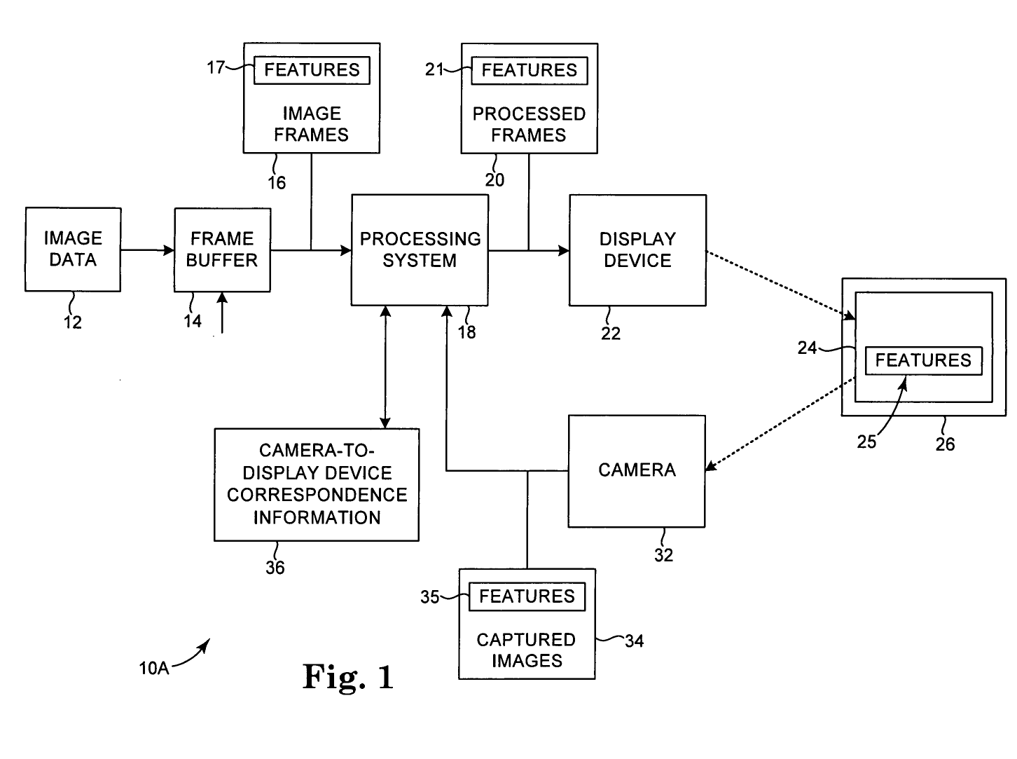

FIG. 1 is a block diagram illustrating one embodiment of an image display system 10A configured to adaptively generate camera-to-display device correspondence information 36 during normal operation.

Image display system 10A processes image data 12 and generates a corresponding displayed image 24 on a display surface 26. In the embodiment of FIG. 1, image display system 10A generates displayed image 24 on display surface 26 such that displayed image 24 does not overlap or only partially overlaps with other images on display surface 26. For example, displayed image 24 may be the only image on display surface 26 or may be adjacent to, tiled with, or partially overlapping with other images (not shown) on display surface 26. Displayed image 24 is defined to include any combination of pictorial, graphical, or textural characters, symbols, illustrations, or other representations of information. Displayed image 24 may form a still image that is displayed on display surface 26 or may be one of a set of successive images in a video stream that is displayed on display surface 26.

An image frame buffer 14 receives and buffers image data 12 to create image frames 16. Processing system 18 processes image frames 16 to define corresponding processed frames 20 and provides processed frames 20 to a display device 22. Display device 22 receives processed frames 20 and stores processed frames 20 in a frame buffer (not shown). Display device 22 displays processed frames 20 onto display surface 26 to produce displayed image 24 for viewing by a user.

Display system 10A includes at least one camera 32 configured to capture images 34 to include displayed images 24 on display surface 26. Camera 32 includes any suitable image capture device configured to capture at least a portion of displayed images 24 on display surface 26.

Processing system 18 compares captured images 34 to processed frames 20 to determine correspondence information 36 between display device 22 and camera 32. Processing system 18 generates processed frames 20 from image frames 16 using correspondence information 36 to adjust geometric and/or photometric features of displayed images 24. The geometric features may include, for example, the size and shape of displayed images 24 on display surface 26, and the photometric features may include, for example, the brightness and color tones of displayed images 24 on display surface 26.

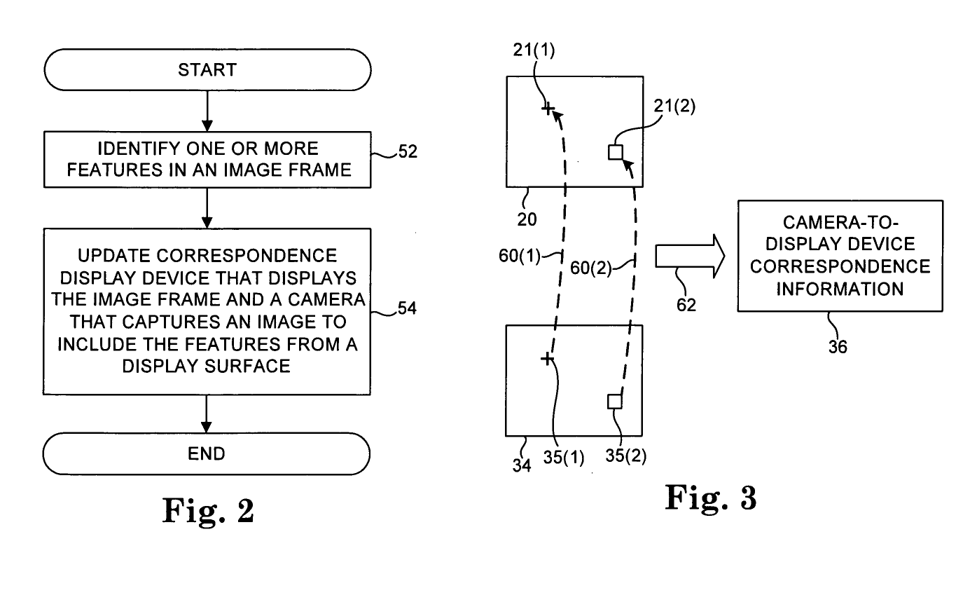

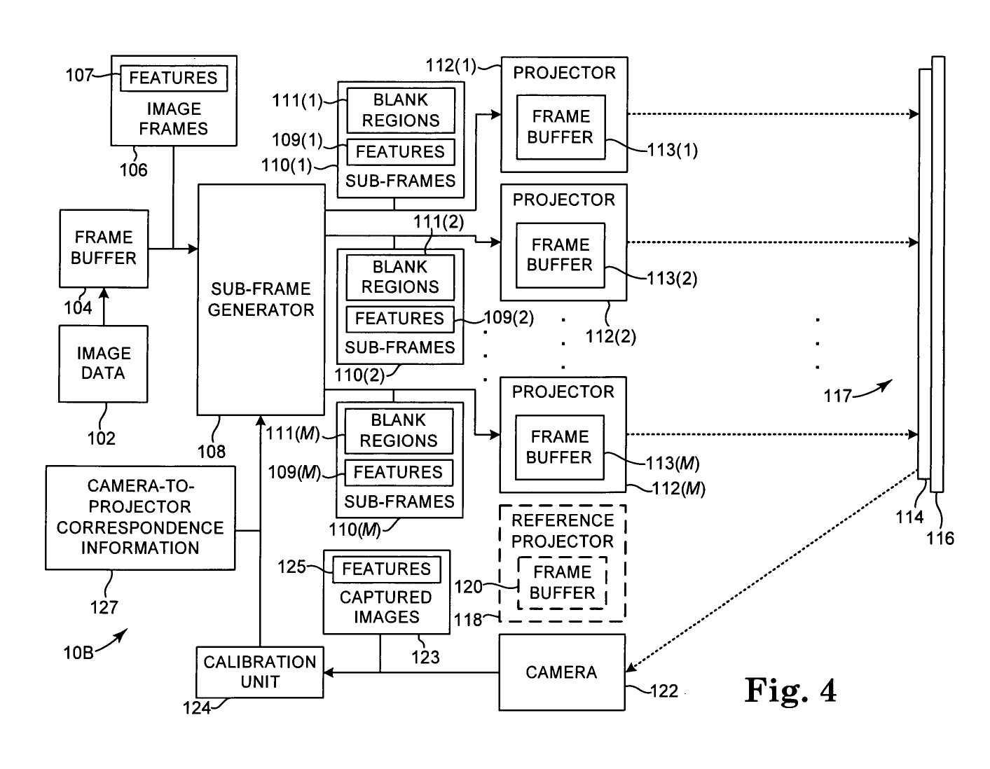

Image display system 10A adaptively generates correspondence information 36 while displaying displayed images 24 on display surface 26. FIG. 2 is a flow chart illustrating one embodiment of a method implemented by image display system 10A for adaptively generating camera-to-display device correspondence information 26. The method may be performed by image display system 10A for each image frame 16 or for selected image frames 16. The method may be performed by image display system 10A continuously or periodically during normal operation of image display system 10A. The method of FIG. 2 will be described with reference to the embodiment of FIG. 1 and with reference to an example of generating updated camera-to-display device correspondence information 36 shown in FIG. 3.

Referring to FIGS. 1, 2, and 3, image display system 10A identifies one or more features 21 in a processed frame 20 that are suitable for use as a fiducial mark when displayed on display surface 26 by display device 22 as indicated in a block 52. Features 21 in processed frame 20 correspond to inherent features 17 in an image frame 16. In the embodiment of FIG. 1, image display system 10A identifies features 21 in processed frame 20 that do not overlap with another image (not shown) displayed on display surface 26.

In one embodiment, processing system 18 examines processed frame 20 to identify features 21 that are suitable for use as a fiducial mark. Features 21 that are suitable for use as fiducial marks include those features, such as corner features with sufficient constrast, that are not positionally ambiguous under the aperture of camera 32 and whose points can be precisely located in a captured image 34. For example, under a small camera aperture, a corner of a large square may fit only one position and may not be positionally ambiguous, whereas a piece of a line segment may fit multiple positions and may be positionally ambiguous in the direction that is parallel to the line. Processing system 18 may use any suitable algorithm to identify features 21 that are suitable for use as a fiducial mark. In the example of FIG. 3, processing system 18 identifies features 21(1) and 21(2) in processed frame 20. Although features 21(1) and 21(2) differ in the example of FIG. 3, features identified in an image frame 21 by processing system 18 may be the same, similar, or different depending on the content of image frame 21.

Image display system 10A updates correspondence information 36 between display device 22 which displays processed frame 20 as displayed image 24 on display surface 26 and camera 32 which captures image 34 to include features 35 from display surface 26 as indicated in a block 54. Display device 22 displays the processed frame 20 onto display surface 26 to form displayed image 24. Displayed image 24 includes features 25 that correspond to features 21 in processed frame 20. Camera 32 captures image 34 to include features 25 in displayed image 24. Thus, features 25 appear in captured image 34 as features 35.

Image display system 10A determines correspondences between features 21 in a processed frame 20 and features 35 in an image 34 captured to include a displayed image 24. To do so, processing system 18 locates features 35 in image 34 that correspond to features 21 in processed frame 20. In the example of FIG. 3, processing system 18 locates features 35(1) and 35(2) that correspond to features 21(1) and 21(2), respectively. In one embodiment, processing system 18 may estimate the location of features 35(1) and 35(2) using previous correspondences from correspondence information 36 and search the regions in image 34 associated with the previous correspondences to locate features 35(1) and 35(2).

Processing system 18 compares the relative locations of features 35 in image 34 to the relative locations of features 21 in processed frame 20, as determined in identifying features 21, to generate correspondences between features 35 and features 21. In FIG. 3, processing system 18 generates a correspondence 60(1) between features 35(1) and 21(1) and a correspondence 60(2) between features 35(2) and 21(2).

Processing system 18 updates correspondence information 36 as indicated by an arrow 62 in FIG. 3. Processing system 18 may update correspondence information 36 using any suitable algorithm or optimization technique. For example, if correspondence information 36 is represented by a multivariable function whose first partial derivative exists for all its variables, processing system 18 may use a conjugate gradient or Newton's approximation method algorithm to update correspondence information 36 and have the function better match the updated correspondences determined by processing system 18. Processing system 18 generates subsequent processed frames 20 using the updated correspondence information 36.

In the above embodiments, features 21 correspond to inherent, arbitrary features 17 in a still or video image frame 16, and image display system 10A identifies features 21 without prior knowledge of the existence or location of features 21 in processed frame 20. Features 21 may be arbitrary in shape, size, configuration, and location in processed frame 20. In addition, some processed frames 20 may not include any features that are suitable for use as fiducial marks. Accordingly, image display system 10A may not determine correspondences using processed frames 20 that do not include features that are suitable for use as fiducial marks.

Using the method of FIG. 2, a viewer of displayed images 24 does not see any fiducial marks in displayed images 24 because the fiducial marks used by image display system 10A to update correspondence information 36 are inherent features of displayed images 24. Accordingly, correspondence information 36 of image display system 10A may be updated during normal operation without interrupting the viewing of displayed images 24.

In the embodiment of FIG. 1, image display system 10A includes hardware, software, firmware, or a combination of these. In one embodiment, one or more components of image display system 10A are included in a computer, computer server, or other microprocessor-based system capable of performing a sequence of logic operations. In addition, processing can be distributed throughout the system with individual portions being implemented in separate system components, such as in a networked or multiple computing unit environments.

Processing system 18 may be implemented in hardware, software, firmware, or any combination thereof. For example, processing system 18 may include a microprocessor, programmable logic device, or state machine. Processing system 18 may also include software stored on one or more computer-readable mediums and executable by processing system 18. The term computer-readable medium as used herein is defined to include any kind of memory, volatile or non-volatile, such as floppy disks, hard disks, CD-ROMs, flash memory, read-only memory, and random access memory.

Image frame buffer 14 includes memory for storing image data 12 for image frames 16. Thus, image frame buffer 14 constitutes a database of image frames 16. Examples of image frame buffer 14 includes non-volatile memory (e.g., a hard disk drive or other persistent storage device) and may include volatile memory (e.g., random access memory (RAM)).

Display device 22 includes any suitable device or devices (e.g., a conventional projector, an LCD projector, a digital micromirror device (DMD) projector, a CRT display, an LCD display, or a DMD display) that are configured to display displayed image 24 onto or in display surface 26.

Display surface 26 may be planar, non-planar, curved, or have any other suitable shape. In one embodiment, display surface 26 reflects light projected by display device 22 to form displayed images 24. In another embodiment, display surface 26 is translucent, and display system 10A is configured as a rear projection system.

In other embodiments, other display devices (not shown) may form images (not shown) on display surface 26 that overlap with displayed image 24. For example, display device 22 may be a portion of a hybrid display system with another type of display device that also displays images onto or in display surface 26. In these embodiments, any images that would overlap with the display of features 25 on display surface 26 may be configured not to interfere with the display of features 25 on display surface 26. For example, blank regions may be included in the additional overlapping images to prevent a spatial overlap between the additional images and features 25. The blank regions may be configured not to add light to features 25 or not to subtract light from features 25 as appropriate.

### II. Adaptive Generation of Camera-to-Projector Corresponce Information in Overlapping Images

A. Image Display System for Projecting Overlapping Images

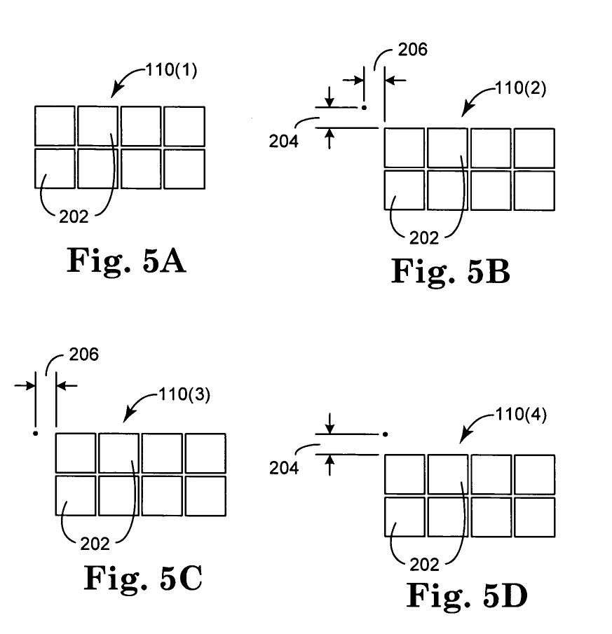

FIG. 4 is a block diagram illustrating an image display system 10B according to one embodiment. Image display system 10B includes an image frame buffer 104, a sub-frame generator 108, projectors 112(1)-112(M) where M is an integer greater than or equal to two (collectively referred to as projectors 112), one or more cameras 122, and calibration unit 124.

Image display system 10B processes image data 102 and generates a corresponding displayed image 114 on a display surface 116. In the embodiment of FIG. 4, image display system 10B generates displayed image 114 on display surface 116 such that displayed image 114 is formed by overlapping or at least partially overlapping images on display surface 116. Displayed image 114 may also be adjacent to, tiled with, or partially overlapping with other images (not shown) on display surface 116. Displayed image 114 is defined to include any combination of pictorial, graphical, or textural characters, symbols, illustrations, or other representations of information. Displayed image 114 may form a still image that is displayed on display surface 116 or may be one of a set of successive images in a video stream that is displayed on display surface 116.

Image frame buffer 104 receives and buffers image data 102 to create image frames 106. Sub-frame generator 108 processes image frames 106 to define corresponding image sub-frames 110(1)-10(M) (collectively referred to as sub-frames 110) where M is an integer that is greater than or equal to two. For each image frame 106, sub-frame generator 108 generates one sub-frame 110 for each projector 112 in one embodiment. Sub-frames 110-110(M) are received by projectors 112-112(M), respectively, and stored in image frame buffers 113-113(M() (collectively referred to as image frame buffers 113), respectively. Projectors 112(1)-112(M) project the sub-frames 110(1)-110(M), respectively, onto display surface 116 in at least partially overlapping and spatially offset positions to produce displayed image 114 for viewing by a user.

In one embodiment, image display system 10B attempts to determine appropriate values for the sub-frames 110 so that displayed image 114 produced by the projected sub-frames 110 is close in appearance to how a corresponding high-resolution image (e.g., a corresponding image frame 106) from which the sub-frame or sub-frames 110 were derived would appear if displayed directly.

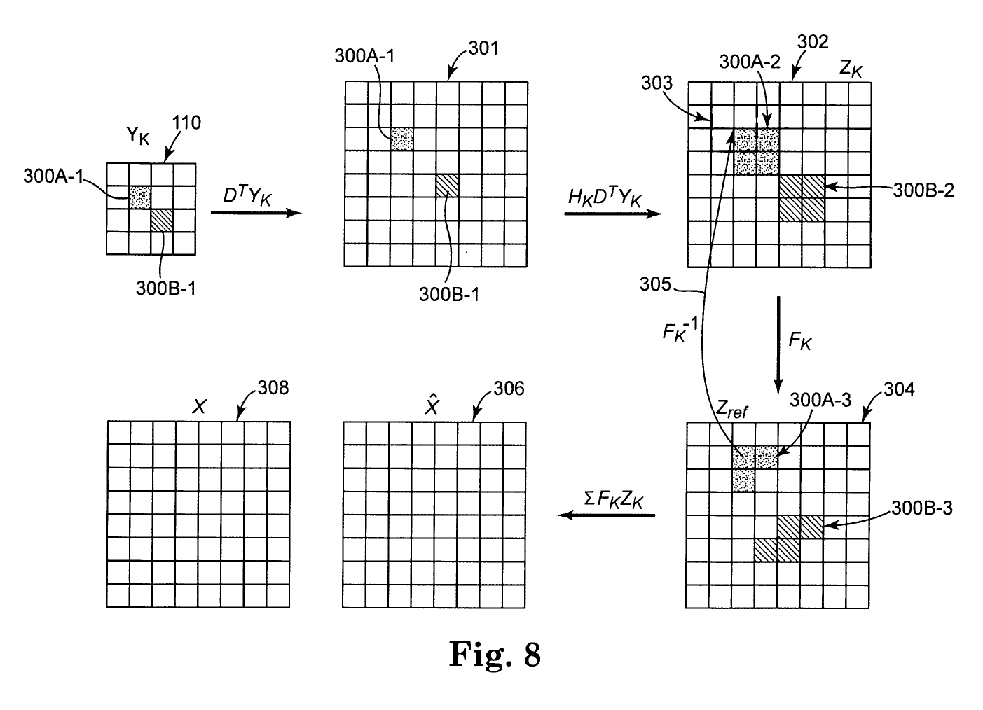

Also shown in FIG. 4 is reference projector 118 with an image frame buffer 120. Reference projector 118 is shown with dashed lines in FIG. 4 because, in one embodiment, projector 118 is not an actual projector but rather a hypothetical high-resolution reference projector that is used in an image formation model for generating optimal sub-frames 110, as described in further detail below with reference to the embodiment of FIG. 8. In one embodiment, the location of one of the actual projectors 112 is defined to be the location of the reference projector 118.

Display system 10B includes at least one camera 122 and calibration unit 124, which are used to automatically determine a geometric relationship between each projector 112 and the reference projector 118, as described in further detail below with reference to the embodiment of FIG. 8. The geometric relationship is stored as camera-to-projector correspondence information 127.

Sub-frame generator 108 forms sub-frames 110 according to a geometric relationship between each of projectors 112 using camera-to-projector correspondence information 127 as described in additional detail below with reference to the embodiment of FIG. 8. With the embodiment of FIG. 8, sub-frame generator 108 forms each sub-frame 110 in full color and each projector 112 projects sub-frames 110 in full color.

In one embodiment, sub-frame generator 108 generates image sub-frames 110 with a resolution that matches the resolution of projectors 112, which is less than the resolution of image frames 106 in one embodiment. Sub-frames 110 each include a plurality of columns and a plurality of rows of individual pixels representing a subset of an image frame 106.

In one embodiment, display system 10B is configured to give the appearance to the human eye of high-resolution displayed images 114 by displaying overlapping and spatially shifted lower-resolution sub-frames 110. The projection of overlapping and spatially shifted sub-frames 110 may give the appearance of enhanced resolution (i.e., higher resolution than the sub-frames 110 themselves).

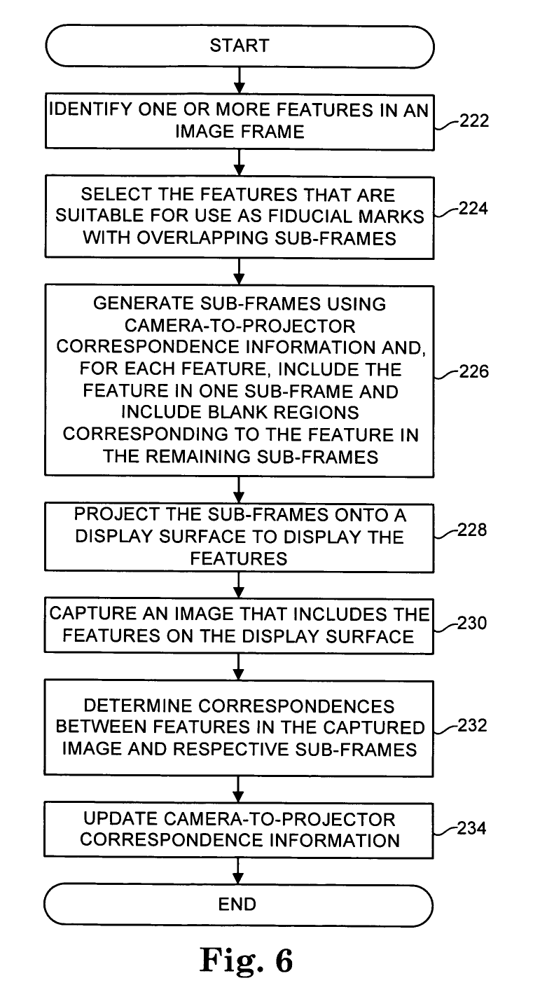

Sub-frames 110 projected onto display surface 116 may have perspective distortions, and the pixels may not appear as perfect squares with no variation in the offsets and overlaps from pixel to pixel, such as that shown in FIGS. 5A-5D. Rather, the pixels of sub-frames 110 may take the form of distorted quadrilaterals or some other shape, and the overlaps may vary as a function of position. Thus, terms such as “spatially shifted” and “spatially offset positions” as used herein are not limited to a particular pixel shape or fixed offsets and overlaps from pixel to pixel, but rather are intended to include any arbitrary pixel shape, and offsets and overlaps that may vary from pixel to pixel.

FIGS. 5A-5D are schematic diagrams illustrating the projection of four sub-frames 110(1), 110(2), 110(3), and 110(4). In this embodiment, projection system 10B includes four projectors 112, and sub-frame generator 108 generates a set of four sub-frames 110(1), 110(2), 110(3), and 110(4) for each image frame 106 for display by projectors 112. As such, sub-frames 110(1), 110(2), 110(3), and 110(4) each include a plurality of columns and a plurality of rows of individual pixels 202 of image data.

FIG. 5A illustrates the display of sub-frame 110(1) by a first projector 112(1). As illustrated in FIG. 5B, a second projector 112(2) displays sub-frame 110(2) offset from sub-frame 110(1) by a vertical distance 204 and a horizontal distance 206. As illustrated in FIG. 5C, a third projector 112(3) displays sub-frame 110(3) offset from sub-frame 110(1) by horizontal distance 206. A fourth projector 112(4) displays sub-frame 110(4) offset from sub-frame 110(1) by vertical distance 204 as illustrated in FIG. 5D.

Sub-frame 110(1) is spatially offset from sub-frame 110(2) by a predetermined distance. Similarly, sub-frame 110(3) is spatially offset from sub-frame 110(4) by a predetermined distance. In one illustrative embodiment, vertical distance 204 and horizontal distance 206 are each approximately one-half of one pixel.

The display of sub-frames 110(2), 110(3), and 110(4) are spatially shifted relative to the display of sub-frame 110(1) by vertical distance 204, horizontal distance 206, or a combination of vertical distance 204 and horizontal distance 206. As such, pixels 202 of sub-frames 110(1), 110(2), 110(3), and 110(4) at least partially overlap thereby producing the appearance of higher resolution pixels. Sub-frames 110(1), 110(2), 110(3), and 110(4) may be superimposed on one another (i.e., fully or substantially fully overlap), may be tiled (i.e., partially overlap at or near the edges), or may be a combination of superimposed and tiled. The overlapped sub-frames 110(1), 110(2), 110(3), and 110(4) also produce a brighter overall image than any of sub-frames 110(1), 110(2), 110(3), or 110(4) alone.

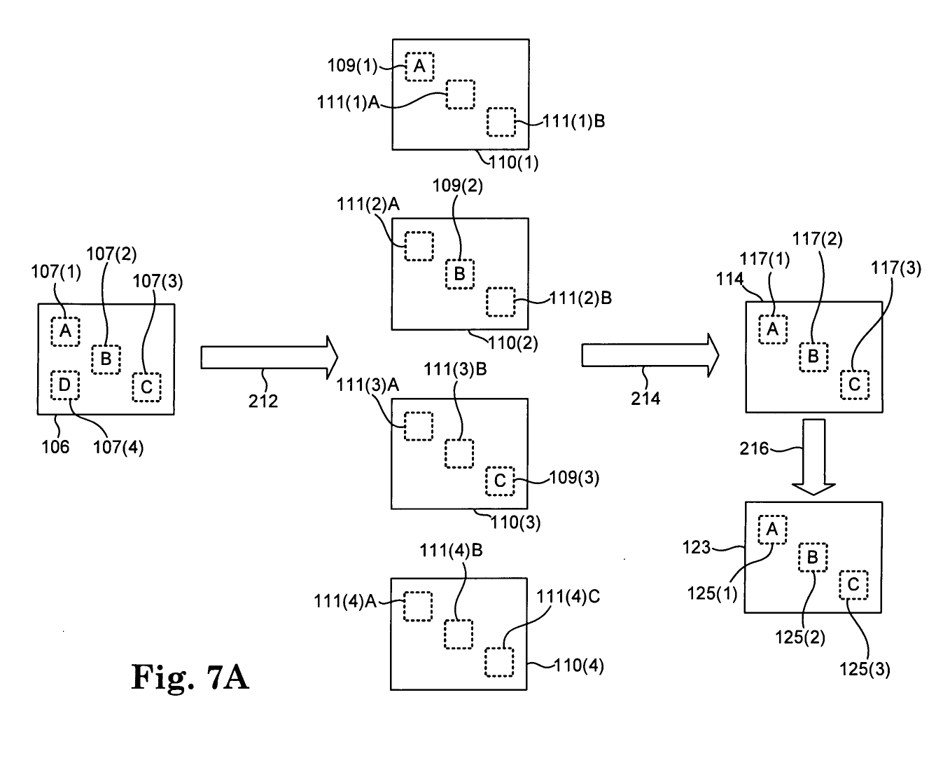

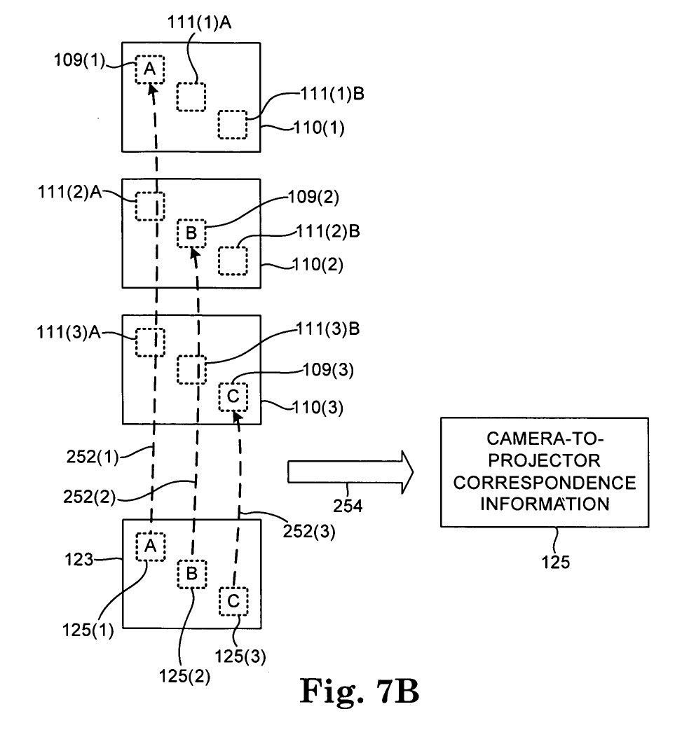

Image display system 10B adaptively generates correspondence information 127 while displaying displayed images 114 on display surface 116. FIG. 6 is a flow chart illustrating one embodiment of a method implemented by image display system 10B for adaptively generating camera-to-projector correspondence information 127 for projectors 112 with at least partially overlapping sub-frames 110. The method may be performed by image display system 10B for each image frame 106 or for selected image frames 106. The method may be performed by image display system 10B continuously or periodically during normal operation of image display system 10B. The method of FIG. 6 will be described with reference to the embodiment of FIG. 4 and with reference to an example of generating updated camera-to-display device correspondence information 36 shown in FIGS. 7A and 7B.

Referring to FIGS. 4, 6, 7A, and 7B, image display system 10B identifies one or more inherent, arbitrary features 107 in an image frame 106 that are suitable for use as a fiducial mark when displayed on display surface 116 by a projector 112 as indicated in a block 222. In one embodiment, sub-frame generator 108 examines processed image frame 106 to identify features 107 that are suitable for use as a fiducial mark. Features 107 that are suitable for use as fiducial marks include those features, such as corner features, that are not positionally ambiguous under the aperture of camera 122 and whose points can be precisely located in a captured image 123. For example, under a small camera aperture, a corner of a large square may fit only one position and may not be positionally ambiguous, whereas a piece of a line segment may fit multiple positions and may be positionally ambiguous in the direction that is parallel to the line. Sub-frame generator 108 may use any suitable algorithm to identify features 107 that are suitable for use as a fiducial mark. In the example of FIG. 6, sub-frame generator 108 identifies features 107(1), 107(2), 107(3), and 107(4) in image frame 106. Features 107(1), 107(2), and 107(3) may be the same, similar, or different depending on the content of image frame 106.

Image display system 10B selects features 107 that are suitable for use as fiducial marks when displayed on display surface 116 by a projector 112 with overlapping sub-frames 110 as indicated in a block 224. Because displayed image 114 is formed from overlapping sub-frames 110 from multiple projectors 112, certain features identified in block 222 may be too bright, too distorted, or otherwise not suited to being formed in displayed image 114 with a single projector 112. Accordingly, sub-frame generator 108 selects features 107 that may be suitably formed in displayed image 114 by a single projector 112 and eliminates features 107 that may not be suitably formed in displayed image 114 by a single projector 112. In the example of FIG. 6, sub-frame generator 108 selects features 107(1), 107(2), and 107(3) which may be suitably formed with a single projector 112 and eliminates feature 107(4) which may not be suitably formed with a single projector 112.

Image display system 10B generates sub-frames 110 using camera-to-projector correspondence information 127 and, for each feature 107, includes feature 107 as a feature 109 in only one of sub-frames 110 and includes blank regions 111 corresponding to the location of feature 109 in the remaining sub-frames 110 as indicated in a block 226. Sub-frame generator 108 generates sub-frames 110 using camera-to-projector correspondence information 127. For each feature 107, sub-frame generator 108 generates sub-frames 110 so that only one sub-frame 110 is configured to include feature 107 as a feature 109 and so that sub-frames 110 that are not configured to display a feature 107 include a blank region 111 corresponding to the location of feature 109. Sub-frame generator 108 may include all features 107 as feature 109 in a single sub-frame 110 or may distribute features 107 as features 109 through two or more sub-frames 110.

In the example of FIG. 7A, sub-frame generator 108 generates sub-frames 110(1), 110(2), and 110(3) to include features 109(1), 109(2), and 109(3), respectively, that correspond to features 107(1), 107(2), and 107(3), respectively. Sub-frame generator 108 generates sub-frame 110(1) to include blank regions 111(1)A and 111(1)B which correspond to features 109(2) and 109(3), respectively. Sub-frame generator 108 also generates sub-frame 110(2) to include blank regions 111(2)A and 111(2)B which correspond to features 109(1) and 109(3), respectively. Sub-frame generator 108 further generates sub-frame 110(3) to include blank regions 111(3)A and 111(3)B which correspond to features 109(1) and 109(2), respectively. In addition, sub-frame generator 108 further generates sub-frame 110(4) to include blank regions 111 (4)A, 111 (4)B, and 11 1(4)C which correspond to features 109(1), 109(2), and 109(3), respectively. Accordingly, sub-frame 110(1) is configured to display feature 107(1) but not features 107(2) and 107(3), sub-frame 110(2) is configured to display feature 107(2) but not features 107(1) and 107(3), sub-frame 110(3) is configured to display feature 107(3) but not features 107(1) and 107(2), and sub-frame 110(4) is not configured to display features 107(1), 107(2), or 107(3).

Image display system 10B projects sub-frames 110 onto display surface 116 to display features 109 in sub-frames 110 as features 117 in displayed image 114 as indicated in a block 228. Projectors 112 project sub-frames 110 onto display surface 116 to form features 117 in displayed image 114 that correspond to features 109 in respective sub-frames 110. In the example of FIG. 7A, projector 112(1) projects sub-frame 110(1) to cause feature 109(1) to be formed as feature 117(1) in displayed image 114, projector 112(2) projects sub-frame 110(2) to cause feature 109(2) to be formed as feature 117(2) in displayed image 114, projector 112(3) projects sub-frame 110(3) to cause feature 109(3) to be formed as feature 117(3) in displayed image 114, and projector 112(4) projects sub-frame 110(4) as indicated by an arrow 214.

Because each feature 107 is displayed using only one sub-frame 110, the regions in displayed image 114 that include displayed features 107 may have a lower resolution that the remainder of displayed image 114 which is displayed using two or more sub-frames 110. Accordingly, these regions in displayed image 114 may be selected in block 224 above to minimize any visual artifacts that may be seen by a viewer of displayed image 114.

Image display system 10B captures an image 123 that includes features 125 captured to include features 117 in displayed image 114 on display surface 116 as indicated in a block 230. Camera 122 captures image 123 to include features 117 in displayed image 114. Thus, features 109 appear in captured image 123 as features 125. . In the example of FIG. 7A, camera 122 captures image 123 that includes features 125(1), 125(2), and 125(3) where features 125(1), 125(2), and 125(3) correspond to features 109(1), 109(2), and 109(3), respectively, in sub-frames 110(1), 110(2), and 110(3), respectively.

Image display system 10B determines correspondences between features 109 in sub-frames 110 and features 125 in an image 125 captured to include displayed image 114 as indicated in a block 232. For each sub-frame 110, calibration unit 124 determines correspondences between features 109 included in that sub-frame 110 and corresponding features 125 in image 123. To do so, calibration unit 124 locates features 125 in image 123 that correspond to features 109 in sub-frame 110. In the example of FIG. 7B, calibration unit 124 locates features 125(1), 125(2), and 125(3) that correspond to features 109(1), 109(2), and 109(3), respectively, in sub-frames 110(1), 110(2), and 110(3), respectively. In one embodiment, calibration unit 124 may estimate the location of features 125(1), 125(2), and 125(3) using previous correspondences from correspondence information 127 and search the regions in image 123 associated with the previous correspondences to locate features 125(1), 125(2), and 125(3).

Calibration unit 124 compares the relative locations of features 125 in image 123 to the relative locations of features 109 in respective sub-frames 110 to determine correspondences between features 125 and features 109. In FIG. 7B, calibration unit 124 determines a correspondence 252(1) between features 125(1) and 109(1) where correspondence 252(1) represents a correspondence between projector 112(1) and camera 122. Calibration unit 124 also determines a correspondence 252(2) between features 125(2) and 109(2) where correspondence 252(2) represents a correspondence between projector 112(2) and camera 122. Calibration unit 124 further determines a correspondence 252(3) between features 125(3) and 109(3) where correspondence 252(3) represents a correspondence between projector 112(3) and camera 122. Calibration unit 124 may determine correspondences 252(1), 252(2), and 252(3), as well as any additional correspondences between additional features for the same or different projectors 112, simultaneously or sequentially.

Image display system 10B updates camera-to-projector correspondence information 127 as indicated in a block 234. Calibration unit 124 updates camera-to-projector correspondence information 127 as indicated by an arrow 254 in FIG. 7B. In the example of FIG. 7B, calibration unit 124 updates the correspondences in camera-to-projector correspondence information 127 for projector 112(1) using correspondence 252(1), calibration unit 124 updates the correspondences in camera-to-projector correspondence information 127 for projector 112(2) using correspondence 252(2), and calibration unit 124 updates the correspondences in camera-to-projector correspondence information 127 for projector 112(3) using correspondence 252(3). Calibration unit 124 may update the correspondences using any suitable algorithm or optimization technique. For example, if correspondence information 127 is represented by a multivariable function whose first partial derivative exists for all its variables, calibration unit 124 may use a conjugate gradient or Newton's approximation method algorithm to update correspondence information 127 and have the function better match the updated correspondences determined in block 232. Calibration unit 124 may store correspondences 252(1), 252(2), and 252(3) and may be accumulated over time with subsequently determined correspondences to improve the correspondence estimation. Sub-frame generator 108 generates subsequent sub-frames 110 using the updated correspondence information 127.

In the above embodiments, features 109 correspond to inherent, arbitrary features 107 in a still or video image frame 106, and image display system 10B identifies features 107 without prior knowledge of the existence or location of features 107 in image frame 106. Features 107 may be arbitrary in shape, size, configuration, and location in image frame 106. In addition, some image frames 106 may not include any features that are suitable for use as fiducial marks. Accordingly, image display system 10B may not generate correspondences using image frames 106 that do not include features that are suitable for use as fiducial marks.

In other embodiments, calibration unit 124 may determine correspondences using an initial guess. In addition, calibration unit 124 may adaptively determine the correspondences where the correspondences for each projector 112 are determined sequentially at first (rather than simultaneously) and subsequently determine updates to correspondences for all projectors 112 simultaneously.

Using the method of FIG. 6, a viewer of displayed images 114 does not see any fiducial marks in displayed images 114 because the fiducial marks used by image display system 10B to update correspondence information 127 are inherent features of displayed images 114. Accordingly, correspondence information 127 of image display system 10B may be updated during normal operation without interrupting the viewing of displayed images 114.

Although the method of FIG. 6 has been described with reference to at least partially overlapping sub-frames 110, the method of FIG. 2 described above may be used to determine correspondences for any projectors 112 that project sub-frames 110 that at least partially do not overlap with other sub-frames 110. Accordingly, the method of FIG. 6 may be used for projectors 112 that correspond to superimposed regions of displayed image 114 and the method of FIG. 2 may be used for any projectors 112 that correspond to regions of displayed images 114 that are not superimposed.

Image display system 10B includes hardware, software, firmware, or a combination of these. In one embodiment, one or more components of image display system 10B are included in a computer, computer server, or other microprocessor-based system capable of performing a sequence of logic operations. In addition, processing can be distributed throughout the system with individual portions being implemented in separate system components, such as in a networked or multiple computing unit environments.

Sub-frame generator 108 and calibration unit 124 may be implemented in hardware, software, firmware, or any combination thereof and may be combined into a unitary processing system. For example, sub-frame generator 108 and calibration unit 124 may include a microprocessor, programmable logic device, or state machine. Sub-frame generator 108 and calibration unit 124 may also include software stored on one or more computer-readable mediums and executable by a processing system (not shown). The term computer-readable medium as used herein is defined to include any kind of memory, volatile or non-volatile, such as floppy disks, hard disks, CD-ROMs, flash memory, read-only memory, and random access memory.

Image frame buffer 104 includes memory for storing image data 102 for image frames 106. Thus, image frame buffer 104 constitutes a database of image frames 106. Image frame buffers 113 also include memory for storing any number of sub-frames 110. Examples of image frame buffers 104 and 113 include non-volatile memory (e.g., a hard disk drive or other persistent storage device) and may include volatile memory (e.g., random access memory (RAM)).

Display surface 116 may be planar, non-planar, curved, or have any other suitable shape. In one embodiment, display surface 116 reflects the light projected by projectors 112 to form displayed image 114. In another embodiment, display surface 116 is translucent, and display system 10B is configured as a rear projection system.

In other embodiments, other numbers of projectors 112 are used in system 10B and other numbers of sub-frames 110 are generated for each image frame 106.

In other embodiments, sub-frames 110(1), 110(2), 110(3), and 110(4) may be displayed at other spatial offsets relative to one another and the spatial offsets may vary over time.

In one embodiment, sub-frames 110 have a lower resolution than image frames 106. Thus, sub-frames 110 are also referred to herein as low-resolution images or sub-frames 110, and image frames 106 are also referred to herein as high-resolution images or frames 106. The terms low resolution and high resolution are used herein in a comparative fashion, and are not limited to any particular minimum or maximum number of pixels.

B. Sub-Frame Generation for Overlapping Images

In one embodiment, sub-frame generator 108 determines appropriate values for each sub-frame 110 using the embodiment described with reference to FIG. 8 below for the portions of sub-frames 110 that do not include a feature 109 or a blank region 111.

In one embodiment, display system 10B produces at least a partially superimposed projected output that takes advantage of natural pixel mis-registration to provide a displayed image with a higher resolution than the individual sub-frames 110. In one embodiment, image formation due to multiple overlapped projectors 112 is modeled using a signal processing model. Optimal sub-frames 110 for each of the component projectors 112 are estimated by sub-frame generator 108 based on the model, such that the resulting image predicted by the signal processing model is as close as possible to the desired high-resolution image to be projected. In one embodiment described with reference to FIG. 8, the signal processing model is used to derive values for sub-frames 110 that minimize visual color artifacts that can occur due to offset projection of single-color sub-frames 110.

In one embodiment, sub-frame generator 108 is configured to generate sub-frames 110 based on the maximization of a probability that, given a desired high resolution image, a simulated high-resolution image that is a function of the sub-frame values, is the same as the given, desired high-resolution image. If the generated sub-frames 110 are optimal, the simulated high-resolution image will be as close as possible to the desired high-resolution image. The generation of optimal sub-frames 110 based on a simulated high-resolution image and a desired high-resolution image is described in further detail below with reference to the embodiment of FIG. 8.

FIG. 8 is a diagram illustrating a model of an image formation process performed by sub-frame generator 108 for in image display system 10B. Sub-frames 110 are represented in the model by Yₖ, where “k” is an index for identifying the individual projectors 112. Thus, Yᵢ, for example, corresponds to a sub-frame 110 for a first projector 112, Y₂ corresponds to a sub-frame 110 for a second projector 112, etc. Two of the sixteen pixels of the sub-frame 110 shown in FIG. 8 are highlighted, and identified by reference numbers 300A-1 and 300B-1. Sub-frames 110 (Yₖ) are represented on a hypothetical high-resolution grid by up-sampling (represented by D^{T}) to create up-sampled image 301. The up-sampled image 301 is filtered with an interpolating filter (represented by Hₖ) to create a high-resolution image 302 (Zₖ) with “chunky pixels”. This relationship is expressed in the following Equation I:

Zₖ=HₖD^{T}Yₖ Equation I

where:
k=index for identifying the projectors 112;
Zₖ=low-resolution sub-frame 110 of the kth projector 112 on a hypothetical high-resolution grid;
Hₖ=Interpolating filter for low-resolution sub-frame 110 from kth projector 112;

D^{T}=up-sampling matrix; and

Yₖ=low-resolution sub-frame 110 of the kth projector 112.

The low-resolution sub-frame pixel data (Yₖ) is expanded with the up-sampling matrix (D^{T}) so that sub-frames 110 (Yₖ) can be represented on a high-resolution grid. The interpolating filter (Hₖ) fills in the missing pixel data produced by up-sampling. In the embodiment shown in FIG. 8, pixel 300A-1 from the original sub-frame 110 (Yₖ) corresponds to four pixels 300A-2 in the high-resolution image 302 (Zₖ), and pixel 300B-1 from the original sub-frame 110 (Yₖ) corresponds to four pixels 300B-2 in the high-resolution image 302 (Zₖ). The resulting image 302 (Zₖ) in Equation I models the output of the kₜₕ projector 112 if there was no relative distortion or noise in the projection process. Relative geometric distortion between the projected component sub-frames 110 results due to the different optical paths and locations of the component projectors 112. A geometric transformation is modeled with the operator, Fₖ, which maps coordinates in the frame buffer 113 of the k^{th} projector 112 to frame buffer 120 of hypothetical reference projector 118 with sub-pixel accuracy, to generate a warped image 304 (Z_{ref}). In one embodiment, Fₖ is linear with respect to pixel intensities, but is non-linear with respect to the coordinate transformations. As shown in FIG. 8, the four pixels 300A-2 in image 302 are mapped to the three pixels 300A-3 in image 304, and the four pixels 300B-2 in image 302 are mapped to the four pixels 300B-3 in image 304.

In one embodiment, the geometric mapping (Fₖ) is a floating-point mapping, but the destinations in the mapping are on an integer grid in image 304. Thus, it is possible for multiple pixels in image 302 to be mapped to the same pixel location in image 304, resulting in missing pixels in image 304. To avoid this situation, in one embodiment, during the forward mapping (Fₖ), the inverse mapping (Fₖ⁻¹) is also utilized as indicated at 305 in FIG. 8. Each destination pixel in image 304 is back projected (i.e., Fₖ⁻¹) to find the corresponding location in image 302. For the embodiment shown in FIG. 8, the location in image 302 corresponding to the upper-left pixel of the pixels 300A-3 in image 304 is the location at the upper-left corner of the group of pixels 300A-2. In one embodiment, the values for the pixels neighboring the identified location in image 302 are combined (e.g., averaged) to form the value for the corresponding pixel in image 304. Thus, for the example shown in FIG. 8, the value for the upper-left pixel in the group of pixels 300A-3 in image 304 is determined by averaging the values for the four pixels within the frame 303 in image 302.

In another embodiment, the forward geometric mapping or warp (Fₖ) is implemented directly, and the inverse mapping (Fₖ⁻¹) is not used. In one form of this embodiment, a scatter operation is performed to eliminate missing pixels. That is, when a pixel in image 302 is mapped to a floating point location in image 304, some of the image data for the pixel is essentially scattered to multiple pixels neighboring the floating point location in image 304. Thus, each pixel in image 304 may receive contributions from multiple pixels in image 302, and each pixel in image 304 is normalized based on the number of contributions it receives.

A superposition/summation of such warped images 304 from all of the component projectors 112 forms a hypothetical or simulated high-resolution image 306 (\grave{X}, also referred to as X-hat herein) in reference projector frame buffer 120, as represented in the following Equation II:

$$\hat{X} = {\sum }_{k}^{ } {F}_{k} {Z}_{k} \qquad Equation II$$

where:
k=index for identifying the projectors 112;
X-hat=hypothetical or simulated high-resolution image 306 in the reference projector frame buffer 120;

Fₖ=operator that maps a low-resolution sub-frame 110 of the kth projector 112 on a hypothetical high-resolution grid to the reference projector frame buffer 120; and
Zₖ=low-resolution sub-frame 110 of kth projector 112 on a hypothetical high-resolution grid, as defined in Equation I.

If the simulated high-resolution image 306 (X-hat) in reference projector frame buffer 120 is identical to a given (desired) high-resolution image 308 (X), the system of component low-resolution projectors 112 would be equivalent to a hypothetical high-resolution projector placed at the same location as hypothetical reference projector 118 and sharing its optical path. In one embodiment, the desired high-resolution images 308 are the high-resolution image frames 106 received by sub-frame generator 108.

In one embodiment, the deviation of the simulated high-resolution image 306 (X-hat) from the desired high-resolution image 308 (X) is modeled as shown in the following Equation III:

X=\grave{X}+η Equation III

where:
X=desired high-resolution frame 308;
X-hat=hypothetical or simulated high-resolution frame 306 in reference projector frame buffer 120; and
η=error or noise term.

As shown in Equation III, the desired high-resolution image 308 (X) is defined as the simulated high-resolution image 306 (X-hat) plus η, which in one embodiment represents zero mean white Gaussian noise.

The solution for the optimal sub-frame data (Yₖ*) for sub-frames 110 is formulated as the optimization given in the following Equation IV:

$${Y}_{k}^{*} = {argmax}_{{Y}_{k}} P ( \hat{X} \vert X ) \qquad Equation IV$$

where:
k=index for identifying the projectors 112;
Yₖ*=optimum low-resolution sub-frame 110 of the kth projector 112;
Yₖ=low-resolution sub-frame 110 of the kth projector 112;
X-hat=hypothetical or simulated high-resolution frame 306 in reference projector frame buffer 120, as defined in Equation II;
X=desired high-resolution frame 308; and
P(X-hat|X)=probability of X-hat given X.

Thus, as indicated by Equation IV, the goal of the optimization is to determine the sub-frame values (Yₖ) that maximize the probability of X-hat given X. Given a desired high-resolution image 308 (X) to be projected, sub-frame generator 108 determines the component sub-frames 110 that maximize the probability that the simulated high-resolution image 306 (X-hat) is the same as or matches the “true” high-resolution image 308 (X).

Using Bayes rule, the probability P(X-hat|X) in Equation IV can be written as shown in the following Equation V:

$$P ( \hat{X} \vert X ) = \frac{P ( X \vert \hat{X} ) P ( \hat{X} )}{P ( X )} \qquad Equation V$$

where:
X-hat=hypothetical or simulated high-resolution frame 306 in reference projector frame buffer 120, as defined in Equation II;
X=desired high-resolution frame 308;
P(X-hat|X)=probability of X-hat given X;
P(X|X-hat)=probability of X given X-hat;
P(X-hat)=prior probability of X-hat; and
P(X)=prior probability of X.

The term P(X) in Equation V is a known constant. If X-hat is given, then, referring to Equation III, X depends only on the noise term, η, which is Gaussian. Thus, the term P(X|X-hat) in Equation V will have a Gaussian form as shown in the following Equation VI:

$$P ( X \vert \hat{X} ) = \frac{1}{C} {e}^{- \frac{{‖ X - \hat{X} ‖}^{2}}{2 {σ}^{2}}} \qquad Equation VI$$

where:
X-hat=hypothetical or simulated high-resolution frame 306 in reference projector frame buffer 120, as defined in Equation II;
X=desired high-resolution frame 308;
P(X|X-hat)=probability of X given X-hat;
C=normalization constant; and
σ=variance of the noise term, η.

To provide a solution that is robust to minor calibration errors and noise, a “smoothness” requirement is imposed on X-hat. In other words, it is assumed that good simulated images 306 have certain properties. The smoothness requirement according to one embodiment is expressed in terms of a desired Gaussian prior probability distribution for X-hat given by the following Equation VII:

$$P ( \hat{X} ) = \frac{1}{Z ( β )} {e}^{- \{ {β}^{2} ( {‖ ∇ \hat{X} ‖}^{2} ) \}} \qquad Equation VII$$

where:
P(X-hat)=prior probability of X-hat;
β=smoothing constant;
Z(β)=normalization function;
∇=gradient operator; and
X-hat=hypothetical or simulated high-resolution frame 306 in reference projector frame buffer 120, as defined in Equation II.

In another embodiment, the smoothness requirement is based on a prior Laplacian model, and is expressed in terms of a probability distribution for X-hat given by the following Equation VIII:

$$P ( \hat{X} ) = \frac{1}{Z ( β )} {e}^{- \{ β ( ‖ ∇ \hat{X} ‖ ) \}} \qquad Equation VIII$$

where:
P(X-hat)=prior probability of X-hat;
β=smoothing constant;
Z(β)=normalization function;
∇=gradient operator; and
X-hat=hypothetical or simulated high-resolution frame 306 in reference projector frame buffer 120, as defined in Equation II.

The following discussion assumes that the probability distribution given in Equation VII, rather than Equation VIII, is being used. As will be understood by persons of ordinary skill in the art, a similar procedure would be followed if Equation VIII were used. Inserting the probability distributions from Equations VI and VII into Equation V, and inserting the result into Equation IV, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation IV is transformed into a function minimization problem, as shown in the following Equation IX:

$${Y}_{k}^{*} = {argmax}_{{Y}_{k}} {‖ X - \hat{X} ‖}^{2} + {β}^{2} {‖ ∇ \hat{X} ‖}^{2} \qquad Equation IX$$

where:
k=index for identifying the projectors 112;
Yₖ*=optimum low-resolution sub-frame 110 of the kth projector 112;
Yₖ=low-resolution sub-frame 110 of the kth projector 112;
X-hat=hypothetical or simulated high-resolution frame 306 in reference projector frame buffer 120, as defined in Equation II;
X=desired high-resolution frame 308;
β=smoothing constant; and
∇=gradient operator.

The function minimization problem given in Equation IX is solved by substituting the definition of X-hat from Equation II into Equation IX and taking the derivative with respect to Yₖ, which results in an iterative algorithm given by the following Equation X:

Yₖ⁽ⁿ⁺¹⁾=Yₖ⁽ⁿ⁾−Θ{DHₖ^{T}Fₖ^{T}└(\grave{X}⁽ⁿ⁾−X)+β²∇²\grave{X}⁽ⁿ⁾┘} Equation X

where:
k=index for identifying the projectors 112;
n=index for identifying iterations;
Yₖ⁽ⁿ⁺¹⁾=low-resolution sub-frame 110 for the kth projector 112 for iteration number n+1;
Yₖ⁽ⁿ⁾=low-resolution sub-frame 110 for the kth projector 112 for iteration number n;
Θ=momentum parameter indicating the fraction of error to be incorporated at each iteration;
D=down-sampling matrix;
Hₖ^{T}=Transpose of interpolating filter, Hₖ, from
Equation I (in the image domain, Hₖ^{T} is a flipped version of Hₖ);
Fₖ^{T}=Transpose of operator, Fₖ, from Equation II (in the image domain, Fₖ^{T} is the inverse of the warp denoted by Fₖ);
X-hat₍ₙ₎=hypothetical or simulated high-resolution frame 306 in the reference projector frame buffer, as defined in Equation II, for iteration number n;
X=desired high-resolution frame 308;
β=smoothing constant; and
∇²=Laplacian operator.

Equation X may be intuitively understood as an iterative process of computing an error in the hypothetical reference projector coordinate system and projecting it back onto the sub-frame data. In one embodiment, sub-frame generator 108 is configured to generate sub-frames 110 in real-time using Equation X. The generated sub-frames 110 are optimal in one embodiment because they maximize the probability that the simulated high-resolution image 306 (X-hat) is the same as the desired high-resolution image 308 (X), and they minimize the error between the simulated high-resolution image 306 and the desired high-resolution image 308. Equation X can be implemented very efficiently with conventional image processing operations (e.g., transformations, down-sampling, and filtering). The iterative algorithm given by Equation X converges rapidly in a few iterations and is very efficient in terms of memory and computation (e.g., a single iteration uses two rows in memory; and multiple iterations may also be rolled into a single step). The iterative algorithm given by Equation X is suitable for real-time implementation, and may be used to generate optimal sub-frames 110 at video rates, for example.

To begin the iterative algorithm defined in Equation X, an initial guess, Yₖ⁽⁰⁾, for sub-frames 110 is determined. In one embodiment, the initial guess for sub-frames 110 is determined by texture mapping the desired high-resolution frame 308 onto sub-frames 110. In one embodiment, the initial guess is determined from the following Equation XI:

Yₖ⁽⁰⁾DBₖFₖ^{T}X Equation XI

where:
k=index for identifying the projectors 112;
Yₖ⁽⁰⁾=initial guess at the sub-frame data for the sub-frame 110 for the kth projector 112;
D=down-sampling matrix;
Bₖ=interpolation filter;
Fₖ=Transpose of operator, Fₖ, from Equation II (in the image domain, Fₖ^{T} is the inverse of the warp denoted by Fₖ); and
X=desired high-resolution frame 308.

Thus, as indicated by Equation XI, the initial guess (Yₖ⁽⁰⁾) is determined by performing a geometric transformation (Fₖ^{T}) on the desired high-resolution frame 308 (X), and filtering (Bₖ) and down-sampling (D) the result. The particular combination of neighboring pixels from the desired high-resolution frame 308 that are used in generating the initial guess (Yₖ⁽⁰⁾) will depend on the selected filter kernel for the interpolation filter (Bₖ).

In another embodiment, the initial guess, Yₖ⁽⁰⁾, for sub-frames 110 is determined from the following Equation XII

Yₖ⁽⁰⁾=DFₖ^{T}X Equation XII

where:
k=index for identifying the projectors 112;
Yₖ⁽⁰⁾=initial guess at the sub-frame data for the sub-frame 110 for the kth projector 112;
D=down-sampling matrix;
Fₖ^{T}=Transpose of operator, Fₖ, from Equation II (in the image domain, Fₖ^{T} is the inverse of the warp denoted by Fₖ); and
X=desired high-resolution frame 308.

Equation XII is the same as Equation XI, except that the interpolation filter (Bₖ) is not used.

Several techniques are available to determine the geometric mapping (Fₖ) between each projector 112 and hypothetical reference projector 118, including manually establishing the mappings, using structured light coding, or using camera 122 and calibration unit 124 to automatically determine the mappings. In one embodiment, if camera 122 and calibration unit 124 are used, the geometric mappings between each projector 112 and camera 122 are determined by calibration unit 124. These projector-to-camera mappings may be denoted by Tₖ, where k is an index for identifying projectors 112. Based on the projector-to-camera mappings (Tₖ), the geometric mappings (Fₖ) between each projector 112 and hypothetical reference projector 118 are determined by calibration unit 124, and provided to sub-frame generator 108. For example, in a display system 10B with two projectors 112(1) and 112(2), assuming the first projector 112(1) is hypothetical reference projector 118, the geometric mapping of the second projector 112(2) to the first (reference) projector 112(1) can be determined as shown in the following Equation XIII:

F₂=T₂T₁⁻¹ Equation XIII

where:
F₂=operator that maps a low-resolution sub-frame 110 of the second projector 112(2) to the first (reference) projector 112(1);
T₁=geometric mapping between the first projector 112(1) and camera 122; and
T₂=geometric mapping between the second projector 112(2) and camera 122.

Calibration unit 124 continually or periodically determines (e.g., once per frame 106) the geometric mappings (Fₖ), stores the geometric mappings (Fₖ) as camera-to-projector correspondence information 127, and provides updated values for the mappings to sub-frame generator 108.

One embodiment provides an image display system 10B with multiple overlapped low-resolution projectors 112 coupled with an efficient real-time (e.g., video rates) image processing algorithm for generating sub-frames 110. In one embodiment, multiple low-resolution, low-cost projectors 112 are used to produce high resolution images at high lumen levels, but at lower cost than existing high-resolution projection systems, such as a single, high-resolution, high-output projector. One embodiment provides a scalable image display system 10B that can provide virtually any desired resolution, brightness, and color, by adding any desired number of component projectors 112 to the system 10B.

In some existing display systems, multiple low-resolution images are displayed with temporal and sub-pixel spatial offsets to enhance resolution. There are some important differences between these existing systems and embodiments described herein. For example, in one embodiment, there is no need for circuitry to offset the projected sub-frames 110 temporally. In one embodiment, sub-frames 110 from the component projectors 112 are projected “in-sync”. As another example, unlike some existing systems where all of the sub-frames go through the same optics and the shifts between sub-frames are all simple translational shifts, in one embodiment, sub-frames 110 are projected through the different optics of the multiple individual projectors 112. In one embodiment, the signal processing model that is used to generate optimal sub-frames 110 takes into account relative geometric distortion among the component sub-frames 110, and is robust to minor calibration errors and noise.

It can be difficult to accurately align projectors into a desired configuration. In one embodiment, regardless of what the particular projector configuration is, even if it is not an optimal alignment, sub-frame generator 108 determines and generates optimal sub-frames 110 for that particular configuration.

Algorithms that seek to enhance resolution by offsetting multiple projection elements have been previously proposed. These methods may assume simple shift offsets between projectors, use frequency domain analyses, and rely on heuristic methods to compute component sub-frames. In contrast, one form of the embodiments described herein utilize an optimal real-time sub-frame generation algorithm that explicitly accounts for arbitrary relative geometric distortion (not limited to homographies) between the component projectors 112, including distortions that occur due to a display surface that is non-planar or has surface non-uniformities. One embodiment generates sub-frames 110 based on a geometric relationship between a hypothetical high-resolution hypothetical reference projector at any arbitrary location and each of the actual low-resolution projectors 112, which may also be positioned at any arbitrary location.

In one embodiment, image display system 10B is configured to project images that have a three-dimensional (3D) appearance. In 3D image display systems, two images, each with a different polarization, are simultaneously projected by two different projectors. One image corresponds to the left eye, and the other image corresponds to the right eye. Conventional 3D image display systems typically suffer from a lack of brightness. In contrast, with one embodiment, a first plurality of the projectors 112 may be used to produce any desired brightness for the first image (e.g., left eye image), and a second plurality of the projectors 112 may be used to produce any desired brightness for the second image (e.g., right eye image). In another embodiment, image display system 10B may be combined or used with other display systems or display techniques, such as tiled displays.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method performed by an image display system, the method comprising:
identifying a first arbitrary feature that is inherent in a first image frame and suitable for use as a first fiducial mark when the first image frame is displayed on a display surface by a display device; and
updating correspondence information between the display device and an image capture device using the first arbitrary feature in the first image frame and an image that is captured to include the first arbitrary feature on the display surface.

2. The method of claim 1 further comprising:
determining a correspondence between the first arbitrary feature in the first image frame and the first arbitrary feature in the image; and
updating the correspondence information using the correspondence.

3. The method of claim 1 further comprising:
displaying the first image frame including the first arbitrary feature on the display surface; and
capturing the image to include the first arbitrary feature on the display surface.

4. The method of claim 1 further comprising:
identifying a second arbitrary feature that is inherent in the first image frame and suitable for use as a second fiducial mark when the second arbitrary feature is displayed on the display surface by the display device; and
updating the correspondence information between the display device and the image capture device using the second arbitrary feature in the first image frame and the image that is captured to include the second arbitrary feature on the display surface.

5. The method of claim 4 wherein the first arbitrary feature differs from the second arbitrary feature.

6. The method of claim 1 further comprising:
displaying a first sub-frame configured to form the first arbitrary feature on the display surface with the display device, the display device including a first projector; and
displaying a second sub-frame configured not to form the first arbitrary feature on the display surface with a second projector such that the second sub-frame at least partially overlaps with the first sub-frame on the display surface.

7. The method of claim 6 further comprising:
generating the first sub-frame to include the first arbitrary feature in a first region of the first sub-frame; and
generating the second sub-frame not to include the first arbitrary feature in a second region of the second sub-frame that is configured to overlap with the first region.

8. The method of claim 1 further comprising:
generating a second image frame for display on the display surface using the set of correspondences subsequent to updating the set of correspondences.

9. The method of claim 1 wherein the first arbitrary feature is a corner feature.

10. An image display system comprising:
a processing system configured to generate first and second sub-frames corresponding to a first image frame such that the first sub-frame includes a first region configured to cause a first feature of the first image frame to be displayed and the second sub-frame includes a second region that at least partially overlaps with the first region on the display surface and is not configured to cause the first feature to be displayed;
first and second projectors configured to simultaneously project the first and the second sub-frames onto a display surface in at least partially overlapping positions; and
an image capture device configured to capture an image to include the first feature as displayed on the display surface;
wherein the processing system is configured to update first correspondence information between the first projector and the image capture device using the first feature in the image.

11. The image display system of claim 10 wherein the processing system is configured to generate the second sub-frame to include a third region configured to cause a second feature to be displayed, and wherein the processing system is configured to generate the first sub-frame to include a fourth region that at least partially overlaps with the third region on the display surface and is not configured to cause the second feature of the first image frame to be displayed.

12. The image display system of claim 11 wherein the image capture device is configured to capture the second image to include the second feature as displayed on the display surface, and wherein the processing system is configured to update second correspondence information between the second projector and the image capture device using the second feature in the image.

13. The image display system of claim 11 wherein the processing system is configured to generate a third sub-frame to include a fifth region that at least partially overlaps with the first region on the display surface and is not configured to cause the first feature of the first image frame to be displayed and a sixth region that at least partially overlaps with the third region on the display surface and is not configured to cause the second feature of the first image frame to be displayed.

14. The image display system of claim 10 wherein the processing system is configured to generate the first and the second sub-frames using the first set of correspondences prior to updating the first correspondence information.

15. The image display system of claim 10 wherein the processing system is configured to generate third and fourth sub-frames corresponding to a second image frame using the first correspondence information subsequent to updating the first set of correspondences.

16. The image display system of claim 10 wherein the processing system is configured to identify the first feature as suitable for use as a fiducial mark.

17. A program product comprising:
a program executable by a processing system for causing the processing system to:
identify an arbitrary feature that is inherent in a image frame that is suitable for use as a fiducial mark when the image frame is displayed on a display surface; and
generate a first correspondence between the arbitrary feature in the image frame and the arbitrary feature in an image captured from the display surface;
a medium for storing the program.

18. The program product of claim 17 wherein the first correspondence identifies a configuration of a projector configured to display the image frame on the display surface and a camera configured to capture the image.

19. The program product of claim 17 wherein the program is executable by the processing system for causing the processing system to:
locate the arbitrary feature in the image using a second correspondence that identifies a configuration of a projector configured to display the image frame on the display surface and a camera configured to capture the image prior to generating the first correspondence.

20. The program product of claim 17 wherein the program is executable by the processing system for causing the processing system to:
update camera-to-projector correspondence information with the first correspondence using one of a conjugate gradient algorithm or a Newton's approximation algorithm.
